(19) United States
(12) Patent Application Publication
(10) Pub. No.: US 2015/0139894 A1
(43) Pub. Date: May 21, 2015

(54) APPARATUS FOR SYNTHETISING TIN DIOXIDE NANOPARTICLES AND METHOD FOR PRODUCING TIN DIOXIDE NANOPARTICLES

(71) Applicant: Faculdades Católicas, Associação sem fins lucrativos, Mantenedora da Pontificia Universidade, Rio de Janeiro-RJ (BR)

(72) Inventors: Diego Manuel Ferreira Lusquinos Fontanez, Rio de Janeiro (BR); Francisco José Moura, Rio de Janeiro (BR)

(21) Appl. No.: 14/398,903

(22) PCT Filed: May 6, 2013
(86) PCT No.: PCT/BR2013/000147

§ 371 Date: Nov. 4, 2014

(30) Foreign Application Priority Data
May 4, 2012 (BR) BR1020120106663

(51) Int. Cl. C01G 19/02; B01J 19/00; B01J 19/24; B01J 12/02

(52) U.S. Cl. CPC C01G 19/02; B01J 12/02; B01J 19/006; B01J 19/2415; B01J 2219/00777; B01J 2219/24; C01P 2004/64; Y10S 977/773; Y10S 977/896; B82Y 40/00
USPC 423/618; 422/162; 977/773; 977/896

(57) ABSTRACT

The following invention relates to a novel and efficient nanoparticles synthesis reactor and process production. More particularly, the present invention is applied to the synthesis of nanostructured tin dioxide. The benefits provided by the invention can be seen in various gaseous reactions where occurs the formation of solid and gaseous phases.

### FIELD OF THE INVENTION

The following invention relates to a novel and efficient nanoparticles synthesis reactor and process production. More particularly, the present invention is applied to the synthesis of nanostructured tin dioxide. The benefits provided by the invention can be seen in various gaseous reactions where occurs the formation of solid and gaseous phases.

### BACKGROUND OF THE INVENTION

The nanostructured tin dioxide has properties such as high electrical conductivity, high transparency in the UV-visible region, high thermal resistance, mechanical and chemical resistance and has many applications through microelectronics, manufacturing of opto-electronic devices, solar cells, catalysts, gas sensors, among others. The main application is gas sensors production.

Various methods and reactors for the synthesis of tin dioxide are described in the literature, such as the sol-gel method, hydrothermal synthesis, etc. But these methods have limitations that prevent them from being implemented in industrial scale, such as difficulties in parameters control, high energy cost, complexity, process cost, and generate dangerous co-products, associated with handling and disposal difficulties.

The present invention provides a tin dioxide nanoparticles synthesis reactor. The initial concept was based on a simple synthesis reaction using tin tetrachloride and water, both in vapor form, generating tin dioxide nanoparticles and hydrochloric acid. Nevertheless, this process can be applied to various gaseous reactions that produce solid and gas phases.

The reactor according to the present invention consists of a tube surrounded by small orifices that allow the passage of the reactant gases. The perpendicular collision between the gas flowing through the orifices, preferentially water vapor, and the gas flowing along the axis of the tube, preferentially tin tetrachloride, that improves the reaction kinetics and conversion, allowing lower temperatures reaction compared to other synthesis methods. Moreover, this reaction can be applied in industrial scale, as can be seen in the production process cited in the present invention. Further, the formed hydrochloric acid, HCl, can be reused to produce tin tetrachloride or commercialized.

The scientific literature and patent research points out some documents related to the present invention. The following paper, Maciel et al “Nanostructured Tin Dioxide Synthesis and Growth of nanocrystals and nanobelts” (Quim. Nova (26) 6, 855-862 (2003)) describes the synthesis of nanostructures of tin dioxide through a solution of supersaturated solid in a process of growth of Sn02 nanobelts through carbothermal reduction at temperatures ranging from 1100° C. to 1200° C. Another scientific article [Maciel et al. “Nanostructured Tin dioxide as a NOx gas sensor” Ceramics 49 (2003) 163-167] describes a process for obtaining nanoparticles of tin dioxide from the dissolved tin citrate, and subsequently comminution of the obtained material. The present invention differs from these documents, as it does not consist of a supersaturated solid solution reaction at high temperatures. The present invention is based on a single process through a gas reaction, using such reactor at low temperatures (around 200° C.).

The US2010/0294728 document describes a production method of zinc oxide and/or tin dioxide nanoparticles using NaOH. The method comprises the steps of a) selecting a compound from a group of oxides (ZnO, or SnO2); b) making a solution with the base material of these oxides (ZnSO₄ or SnCl₄); c) diluting this solution with distilled water; e) mixing the obtained solution; f) adding the NaOH solution until the formation of a white precipitate; g) pH control and stirring the solution; h) filtration of the solution to obtain a precipitate separately; i) drying the precipitate; j) calcination of the precipitate. The present invention differs from this document, as it comprises a reactor for the production of tin dioxide in the form of nanoparticles and a process for the production of tin dioxide in the form of nanoparticles using such reactor, which was not described nor suggested in that document.

What is evident from the literature mentioned herein is that no documents were found suggesting or anticipating the findings of the present invention, so that the solution proposed here possesses novelty and inventive activity against the prior art.

### SUMMARY OF THE INVENTION

The present invention provides a reactor and method for the production of nanoparticles of tin dioxide in a single process. The process of the present invention comprises a simple reaction, at relatively low temperatures (about 200° C.) in a continuous flow system. Thus, the present invention provides a novel and inventive reactor for carrying out the described process with high energy efficiency achieved with low reaction temperature, relatively fast SnO₂ production obtained through increased kinetics, process simplicity and small SnO₂ crystallite size, essential for the quality of the gas sensor made from this material. However the benefits of this equipment is generally applicable to other gaseous reactions, not only for the synthesis of tin dioxide.

One of the main advantages of the present invention is to provide a reactor which presents a novel and inventive form of interaction between the reactants, in which the vapor water flow is distributed by orifices surrounding the tubular reactor. Meanwhile, the reactant gas, preferentially tin tetrachloride, flows through the axis of the tubular reactor.

This new configuration improved the reaction kinetics and conversion, allowing lower temperatures reaction compared to other synthesis methods. The collisions among the molecules of water and SnCl₄, occur more energetically when the gaseous (SnCl₄) flow collides with the curtain of water vapor created by the distributor than when the SnCl₄ finds a more stable atmosphere of water vapor. The increased reaction kinetics was confirmed by comparison with other reactors due to the lower temperature and less time required.

Therefore, an object of the present invention is to provide a reactor for the synthesis of nanoparticles comprising:
a) means for the interaction between the reactants flows;
b) means to optimize the continuous flow gases around the reactor
c) means for heating the reactor, allowing the reaction:

A(g)+B(g)→C(s)+D(g)

In a preferential embodiment, the present invention provides the particle size reduction of the synthesized solid; increasing of the solid production at a lower reaction temperature and/or reaction time. In a preferential embodiment, the reactor described above is used for the tin dioxide nanoparticles synthesis (SnO2).

In a preferential embodiment, A(g)=SnCl₄(g); B(g)=H₂O(g); C(s)=SnO₂; D(g)=HCl (g).

In a preferential embodiment, the reaction temperature is about 200° C.

Additionally, another object of the present invention is the process of producing nanoparticles comprising the steps of:
a) means for the interaction between the reactants flows;
b) means to optimize the continuous flow gases around the reactor
c) means for heating the reactor, allowing the reaction:

A(g)+B(g)→C(s)+D(g)

These and other objects of the invention will be immediately appreciated by those skilled in the art and companies of the segment, and will be described below with sufficient detail for its perfect reproduction.

### BRIEF DESCRIPTION OF THE FIGURES

The attached figures represent schematic illustrations of the present invention, which has no sense of restriction or limitation of the scope or the range of the invention. The mentioned figures represent:

FIG. 1—Tubular reactor provided with the gas distributor

FIG. 2—Tubular reactor cut, detailing the gas distributor.

FIG. 3—Equilibrium composition versus temperature of the synthesis reaction.

FIG. 4—XRD of a SnO₂ sample synthesized using the present invention.

FIG. 5—EDS of a SnO₂ sample synthesized using the present invention.

FIG. 6—Simplified schematic of industrial production using the present invention reactor and process.

FIG. 7—Equilibrium composition versus temperature of the Cl₂ production reaction shown in the simplified schematic of industrial production.

FIG. 8—Equilibrium composition versus temperature composition of the Sn chlorination reaction shown in the simplified schematic of industrial production.

FIG. 9—High-resolution transmission electron microscopy (HRTEM) of the sample produced by the current state of technique. Scale: 50 nm.

FIG. 10—High-resolution transmission electron microscopy (HRTEM) of the sample produced by the current state of technique. Scale: 10 nm.

### DETAILED DESCRIPTION OF THE INVENTION

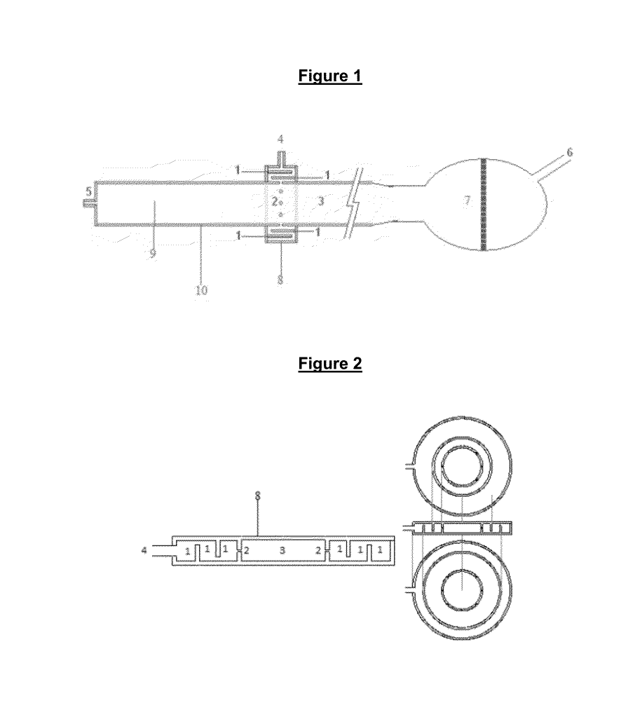

The following is the detailed description of a preferential embodiment of the present invention, which has no sense of restriction or limitation of the scope or the range of the invention. The reactor of the present invention is illustrated in FIGS. 1 and 2. In the reactor (10) of the present invention the flows of tin tetrachloride and water vapor collide perpendicularly, in order to maximize the probability of contact and the energy involved in the collision. The water vapor enters trough the inlet (4) located at the gas distributor (8), while the tetrachloride enters parallel to the axis of the tubular reactor (9) trough the inlet (5). The tubular section (9) is provided with the gas distributor, designed in a way that the water vapor flow and the carrier gas passes through the baffles (1) redirecting part of the mixture (water vapor and carrier gas) into the lower orifices of the reactor (tube). Thus, the mixture (water vapor and the carrier gas) is distributed evenly among the orifices (2) of the tubular section (9), and then collide perpendicularly with the tin tetrachloride flow.

The reaction occurs along the tube, region (3), where the temperature is maintained at 200° C. The tin dioxide nanoparticles are collected in the powder collector (7) while the hydrogen chloride gas produced along with other gases leave the reactor (6) for subsequent treatment or reuse on the industrial production scheme as shown in FIG. 6.

Tetrachloride and the water, in the liquid phase at room temperature, are volatilized by heaters. Then argon is used as a carrier gas to transport these reagents to the reactor. The heating of the reactor is done by resistances installed around the tube.

Experiments carried out using the above methods, but using a conventional reactor, produced tin dioxide nanoparticles sizes ranging from 25 to 45 nm, shown by the TEM images (FIGS. 9 and 10). In these previous experiments the reagent flows parallel, however, in the present invention, the flows are conducted perpendicularly, allowing a kinetically more favorable interaction among the reagents. This was demonstrated by the lower temperature required for the reaction. The reaction temperature decreased from 700° C. to 200° C.

FIG. 3 shows the equilibrium composition versus temperature of the synthesis reaction, using HSC Chemistry®. 5 kmol H2O (g) and 1 kmol of SnCl₄ (g) were calculated. It is important to notice that the software calculations are based on closed systems. As the process of the present invention is an open system, it is expected a higher conversion at lower temperatures, as evidenced in the experiments presented here, thus increasing the viability of the inventive process.

The results shown here were obtained by the analysis of tin dioxide samples collected at the end of the reactor and the powder collector. The following are the parameters and test results, to the date, more satisfactory.

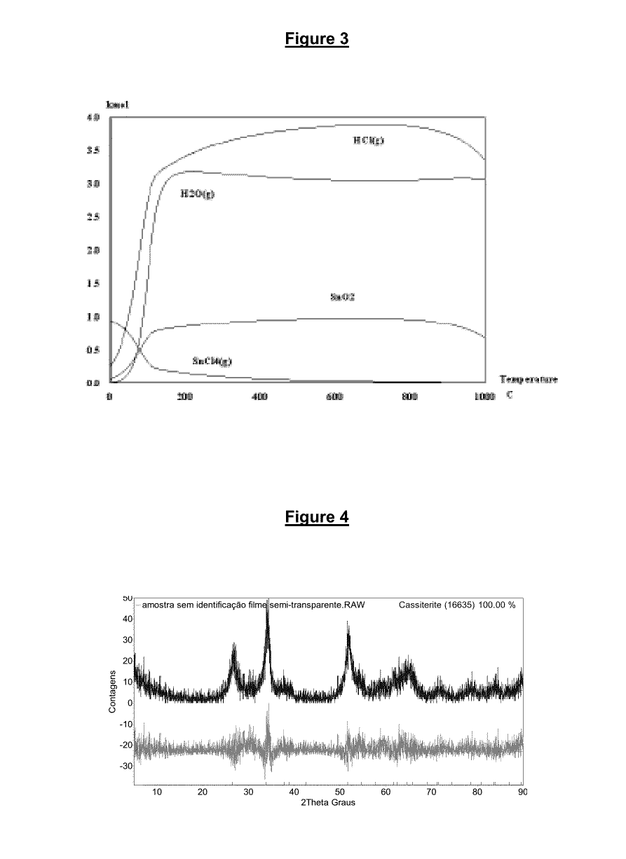

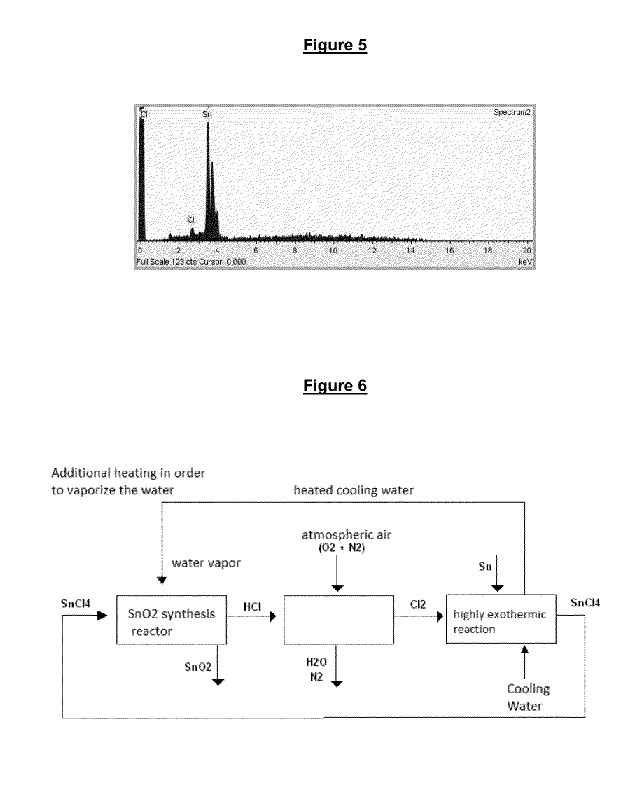

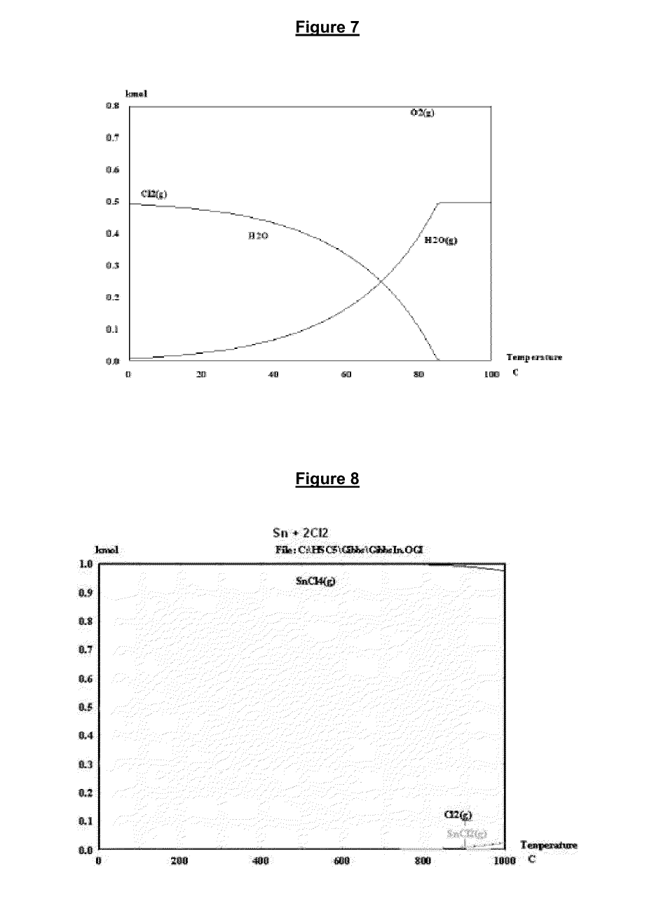

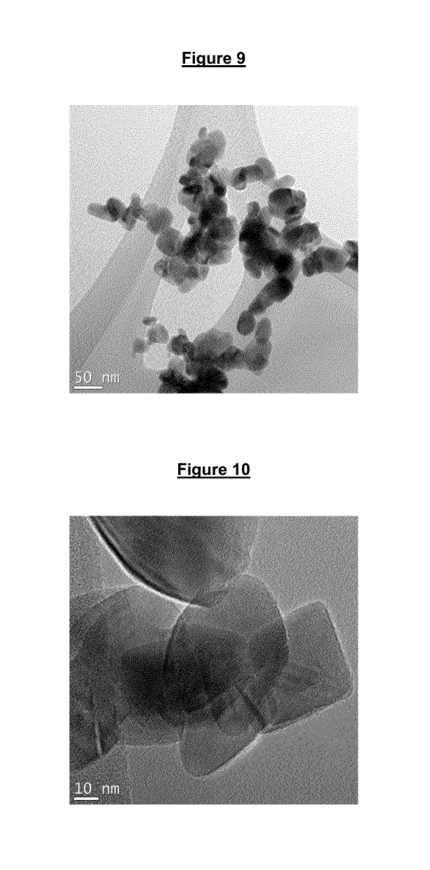

The SnO₂ produced was analyzed using EDS (energy dispersive spectroscopy) and XRD (X-ray Diffraction). The crystallite size using the XRD shown in FIG. 4 was approximately 3 nm. This crystallite size is smaller than the 45 nm from the gaseous reaction using a conventional reactor. The quality of the tin dioxide gas sensor strongly improves with the decrease of particle size. The present invention reactor also allows the reaction temperature reduction in 500° C. The EDS of the sample (FIG. 5) shows the strong presence of tin, confirming the purity of the sample and the high rate of conversion of the reaction system.

FIG. 6 illustrates a simplified diagram of an industrial SnO₂ nanoparticles production. The first reactor performs the SnO₂ synthesis, receiving the reagents SnCl₄ and water vapor. The SnO₂ is collected and the co-product of this reaction, the gaseous HCl, is transported to a second reactor. The reactor for generation of Cl₂ receives atmospheric air, whose oxygen reacts with HCl to form water, which is discarded, and chlorine gas (Cl₂) according to the reaction:

4HCl_{(g)}+O_{2(g)}=2H₂O+2O_{2(g)}

The thermodynamic study shown in FIG. 7 points to 100% conversion at low temperatures (room temperature), contributing to the viability of the energy cost. 1 kmol of HCl (g) and 2 kmol O2 (g) were calculated. In this case the reaction is also gaseous, and the interaction between the reactants is crucial. Therefore, a reactor equivalent to the one used for the SnO₂ synthesis also present benefits being used in the generation of Cl₂.

However, it should be noted that reactions involving hydrochloric add are complicated due to corrosion and environmental cares. If it is not of interest to perform the chlorination of tin for producing SnCl₄, the HCl itself can be commercialized.

Again it is important to remember that the software used for thermodynamic studies performs its calculations based on a closed system. As shown by the experimental results, the practical results were thermodynamically more promising than the theoretical. The satisfactory theoretical calculations presented here for the industrial system are an indication that the same may occur at larger scales and in other reactions, since they also occur in open systems. Table 1 shows the thermodynamic data of the Cl₂ synthesis reaction at different temperatures.

TABLE 1
thermodynamic data of the Cl₂ synthesis reaction at different temperatures.
4HCl(g) + O2(g) = 2H2O + 2Cl2(g)

| T | deltaH | deltaS | deltaG | | |
|---|---|---|---|---|---|
| C. | kcal | cal/K | kcal | K | Log(K) |
| 0.000 | −51.678 | −99.649 | −24.459 | 3.726E+019 | 19.571 |
| 100.000 | −47.049 | −83.665 | −15.830 | 1.871E+009 | 9.272 |
| 200.000 | −45.134 | −79.130 | −7.694 | 3.583E+003 | 3.554 |
| 300.000 | −42.720 | −74.526 | −0.005 | 1.004E+000 | 0.002 |
| 400.000 | −39.092 | −68.705 | 7.156 | 4.746E−003 | −2.324 |
| 500.000 | −35.388 | −63.573 | 13.764 | 1.285E−004 | −3.891 |
| 600.000 | −31.740 | −59.136 | 19.894 | 1.047E−005 | −4.980 |
| 700.000 | −28.156 | −55.249 | 25.609 | 1.771E−006 | −5.752 |
| 800.000 | −24.630 | −51.799 | 30.958 | 4.951E−007 | −6.305 |
| 900.000 | −21.159 | −48.706 | 35.981 | 1.979E−007 | −6.704 |
| 1000.000 | −17.738 | −45.908 | 40.709 | 1.026E−007 | −6.989 |

The Cl₂ generated is then transported to a third reactor, which also receives tin in order to react with the Cl₂, producing the SnCl₄ required for the SnO₂ synthesis reaction in the first reactor. The chlorination of tin is highly exothermic, requiring the cooling system in order to achieve a higher conversion. Thus water is used, which in addition to performing the cooling of the third reactor, uses the energy of chlorination to be vaporized and reacted with SnCl₄ in the first reactor.

FIG. 8 shows the thermodynamic study of chlorination. 1 kmol Sn (s) and kmol 2 Cl2 (g) were calculated. The reaction has a conversion close to 100% from room temperature to 740° C. Table 2 presents the thermodynamic data of chlorination of tin at different temperatures.

TABLE 2
Tin chlorination thermodynamic data for different temperatures
Sn + 2Cl2(g) = SnCl4(g)

| T | deltaH | deltaS | deltaG | | |
|---|---|---|---|---|---|
| C. | kcal | cal/K | kcal | K | Log(K) |
| 0.000 | −114.376 | −31.251 | −105.840 | 4.900E+084 | 84.690 |
| 100.000 | −114.295 | −30.999 | −102.728 | 1.484E+060 | 60.171 |
| 200.000 | −114.231 | −30.846 | −99.636 | 1.062E+046 | 46.026 |
| 300.000 | −115.884 | −34.124 | −96.326 | 5.411E+036 | 36.733 |
| 400.000 | −115.792 | −33.976 | −92.921 | 1.482E+030 | 30.171 |
| 500.000 | −115.691 | −33.837 | −89.530 | 2.042E+025 | 25.310 |
| 600.000 | −115.588 | −33.712 | −86.153 | 3.680E+021 | 21.566 |
| 700.000 | −115.486 | −33.601 | −82.787 | 3.925E+018 | 18.594 |
| 800.000 | −115.386 | −33.503 | −79.432 | 1.506E+016 | 16.178 |
| 900.000 | −115.290 | −33.417 | −76.086 | 1.498E+014 | 14.176 |
| 1000.000 | −115.198 | −33.342 | −72.748 | 3.084E+012 | 12.489 |

Thus, the only reagents that need to be continually provided to this industrial production system are tin, atmospheric air and water, substances much cheaper than those used in other synthesis methods.

The low temperature requirements for the SnO₂ synthesis and the energy reuse in order to vaporize the water also provides advantages over other methods as well.

Those skilled in the art will appreciate the fact that the process object of the present invention applied to the production of nanoparticles, is preferentially nanoparticles of SnO2, has industrial reproducibility, and provides several advantages over other synthesis methods. The benefits of reduced temperature and time required for the reaction is generally applicable to other gaseous reactions, also included by the present invention.

1. A nanoparticles synthesis reactor comprising:
a tubular section provided with an inlet, a gas distributor, which has a circular shape provided with an inlet, baffles and orifices;
said tubular section is provided with a tubular region of reaction, a powder collector which has an outlet;
wherein the orifices provide the perpendicular interaction among the reagents flows;
wherein the baffles provide means for the optimization of the gas flow around the reactor where the reagents flow, so that the following reaction will occur:
A(g)+B(g)→C(s)+D(g).

2. The reactor according to claim 1, characterized as being used for the tin dioxide nanoparticles synthesis (SnO₂) using water vapor.

3. The reactor according to claim 1, characterized by the fact that A(g)=SnCl₄(g); B(g)=H₂O; C(s)=SnO₂(s); D(g)=HCl(g).

4. The reactor according to claim 2, characterized as being capable of maintaining the reaction temperature approximately 200° C.

5. The reactor according to claim 1, characterized by the fact that it provides the particle size reduction of the synthesized solids, optimizing reaction conversion; temperature and/or reaction time.

6. A tin dioxide nanoparticle production process comprising the following steps:
(i) providing a distributor with water vapor through an inlet;
(ii) optimizing water vapor flow through baffles;
(iii) distributing the water vapor flow, uniformly, through orifices around a tubular section where tin tetrachloride gas flows.
(iv) providing a tubular section with tin tetrachloride gas through an the inlet;
(v) providing a perpendicular interaction between the tin tetrachloride gas flow and the water vapor flow, where water vapor is distributed through the orifices that are localized around the tubular section;
(vi) maintaining a reactor temperature of approximately 200° C., allowing the occurrence of the following reaction:
A(g)+B(g)→C(s)+D(g).

7. The process according to claim 6 wherein A(g)=SnCl₄(g); B(g)=H₂O; C(s)=SnO₂(s); D(g)=HCl(g).

8. The process according to claim 6, wherein 3 nm size tin dioxide nanoparticles (SnO₂) are produced.

9. The process according to claim 6, further comprising producing tin dioxide nanoparticles (SnO₂), wherein the a first reactor is provided with SnCl₄ and water vapor, producing SnO₂ that is collected and the co-product, gaseous HCl, that is carried to the a second reactor, the Cl₂ production reactor, which is provided with atmospheric air, and the water is discarded.

10. The process according to claim 6, wherein HCl produced by the synthesis is used to perform tin chlorination in order to produce tin tetrachloride (SnCl₄).

11. The process according to claim 10, wherein HCl produced by the synthesis is collected after the first reactor.
